(19) United States
(12) Patent Application Publication
(10) Pub. No.: US 2012/0286554 A1
(43) Pub. Date: Nov. 15, 2012

(54) Tilt Resistant Seat Swivel

(75) Inventor: Brian Moon, Sycamore, IL (US)

(73) Assignee: The Norix Group, West Chicago, IL (US)

(21) Appl. No.: 12/906,447

(22) Filed: Oct. 18, 2010

(51) Int. Cl. A47C 3/18; B23P 11/00

(52) U.S. Cl. 297/344.21; 297/311; 29/428

(57) ABSTRACT

The invention is directed to an anti-tilt swivel mechanism attaching a seat to a base. The mechanism adapted to control the tilting movement urged on the swivel mechanism when a user shifts weight on the seat. The anti-tilt swivel mechanism comprises a tilt stop mounted on the swivel mechanism to move with the chair and engage the base plate along a front edge. The anti-tilt seat swivel mechanism adapted to engage the base plate when a tilting force is applied to the chair preventing the force from being transmitted as a bending force on the swivel mechanism at the mounting plates or the pivot rod.

### FIELD OF THE INVENTION

The present invention relates generally to an anti-tilt swivel mount for chairs and stools for allowing a chair seat to swivel about a chair base. The swivel seat may be mounted on a fixed or movable base.

### BACKGROUND OF THE INVENTION

Swivel mounting mechanisms are used to provide a swiveling seat attached to a chair base to help a person enter and exit a seat. A swiveling seat may also used to accommodate the user pivoting about a chair base to perform several tasks without adjusting the base of the chair. The seat is connected to the base by a generally vertical mounting pin allowing the seat to rotate about the axis of the mounting pin. Prior art swivel seats may be connected to a base by a mechanism having a plate on the chair, a base plate on the base and a pivot pin fixed to one plate and rotationally connected to the other plate. If the user shifts his weight or leans to one side, a bending load on the pivot pin may bend or break the pin causing failure of the chair.

Prior art swivel disclose a swiveling mechanism using outboard bearing support devices or clamps made from material such as steel and Nylon on the outer edges of rotationally connected plates. The outboard bearing supports extended inwardly between or around the rotationally connected plates to hold the plates in spaced relation. The designs depend on the rigidity of the swivel mechanism to support the tilt resistant mechanisms.

Alternate designs use a retaining bolt extending between the two swiveling plates to limit deflection of the plates. One of the plates may be connected to a base plate with the other connected to a seat. The slots are used to limit angular rotation about the axis. The fastener on the retaining pin spaced a predetermined distance from a head on the retaining pin to limit tilting about the axis point by limiting the spreading of the plates. The short moment arm between the retaining pin and the pivot pin may cause failure under the weight of a large user.

Each of these tilt resisting designs in the prior art is integrally manufactured with the swivel base and depends on the strength of the entire swivel mechanism to limit tilting increasing the cost and complicating the design. In addition, the swiveling seat manufacturer is limited to tilt resistant swivel mechanism designs. Therefore, it is desirable to provide an anti-tilt seat swivel design adaptable to existing, mass-produced and readily available swivel mechanisms.

### BRIEF SUMMARY OF THE INVENTION

One embodiment of the present invention may be directed to a swivel mechanism for use with a mounted chair seat on a base such as a legged chair bottom or seat support on a table. The swivel mechanism assembly comprises a base plate mounted on a fixed support such as a chair base, a top swivel plate mounted on the bottom of the seat, a pivot rod or bolt may be pivotally mounted in the base plate and top swivel plate. The pivot rod having a support end extending through the base plate, a seat end extending through the top swivel plate to hold the top swivel plate and bottom swivel plate axially aligned with a bearing channel circumferentially formed about the pivot rod in one of the top swivel plate or bottom swivel plate , a bearing in the channel bearing against the other of the top swivel plate or chair base to hold the top swivel plate and top swivel plate in generally parallel, spaced relation and allow the chair base to rotate with respect to the top swivel plate about the pivot rod.

The invention may include a tilt stop on the front of the top swivel plate having a rigid tilt stop held in spaced relation to the top swivel plate such that the bottom swivel plate may be between the top swivel plate and the chair base stop. The tilt stop may circumferentially move with the top swivel plate as the top swivel plate pivots about the pivot rod. The chair tilt stop moves in a generally vertical direction when the user shifts weight by leaning against the chair back causing a lifting or tilting force to be applied to the front of the top swivel plate. The tilt stop engages the chair base to prevent transfer of the tilting motion of the chair to the pivot pin and hold the top swivel plate and bottom swivel plate together. The tilt stop also prevents the bearing spacing distance from increasing, a bending load imposed on the rod or deformation of the top swivel plate or bottom swivel plate.

The tilt stop may have a “U” shape with both vertical ends of the tilt stop attached to the chair thing and a crossbar adapted to engage the base. The chair base may be adapted with a shape to accommodate rotation of the chair with respect to the base causing the tilt stopped to move with the chair about the pivot pin. The crossbar held in spaced relation to the chair surrounding a front portion of the base plate. The pivot pin comprising an axis of rotation of the chair and tilt stop. The pivot pin mounted on the bottom swivel plate generally at a center point of the generally round base plate. The tilt stop moving circumferentially around the base plate as the chair rotates. The tilt stop attached to the top swivel plate and disposed to engage the tilt stop in the rotational range of the swivel mechanism. The allowable swivel rotational range of the seat may be limited by cogs on the bottom swivel plate engaging mating stops formed on the chair base or engaging the tilt stop.

The above description sets forth, rather broadly, the more important features of the present invention so that the detailed description of the preferred embodiment that follows may be better understood and contributions of the present invention to the art may be better appreciated. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE SEVERAL VIEWS OF THE DRAWING

FIG. 1 is substantially a perspective view of a first embodiment of the invention.

FIG. 2 is substantially a side elevation view of a second embodiment of the invention.

FIG. 3 is substantially a section view of the first embodiment taken at approximately 3-3 of FIG. 1.

FIG. 4 is substantially an exploded view of the first embodiment.

FIG. 5 is substantially an alternate bottom plan view of the first embodiment.

FIG. 6 is substantially a top perspective view of the pinch guard of the second embodiment.

FIG. 7 is substantially a bottom perspective view of the pinch guard of the second embodiment.

FIG. 8 is substantially a bottom perspective view of the second embodiment.

### DETAILED DESCRIPTION OF THE INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

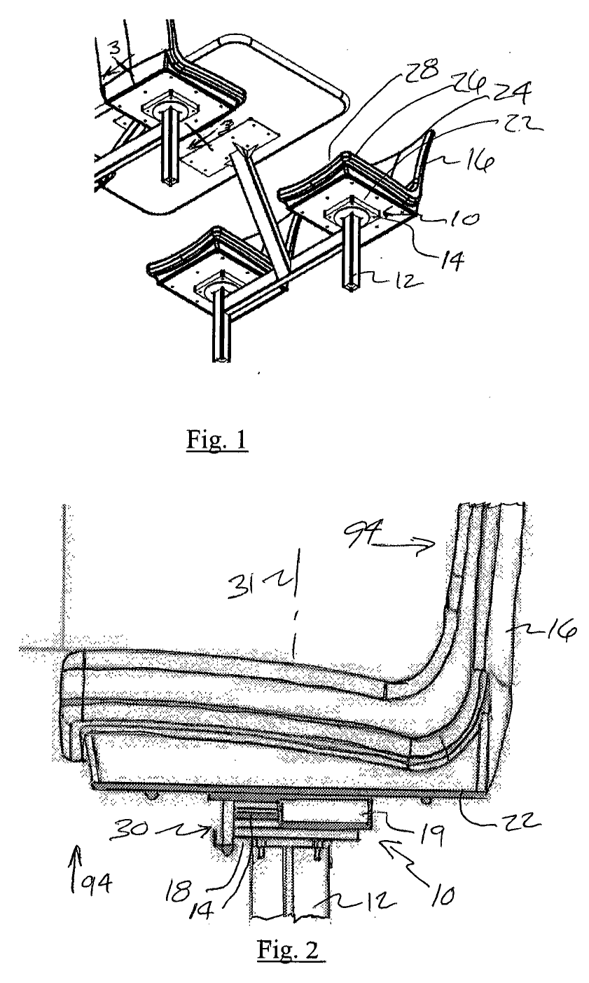

Referring to FIG. 1, an anti-tilt swivel mechanism may be generally referred to by the number 10 may comprise a base 12 pivotally connected by a swivel mechanism 14 to a chair 16. The base may comprise a base plate 18 on the base 12 pivotally attached to a chair plate 20 on the chair 16. Chair 16 further comprises a chair bottom 22, chair back 24, chair seat 26, and chair front 28. Chair seat 26 may be attached to chair back to 24 and spaced from chair front 28. Base 12 may be a single pedestal or a frame supporting a plurality of base plates 18 as shown. Alternatively, base plate 18 may be mounted on a bench, wall or other support surface. A

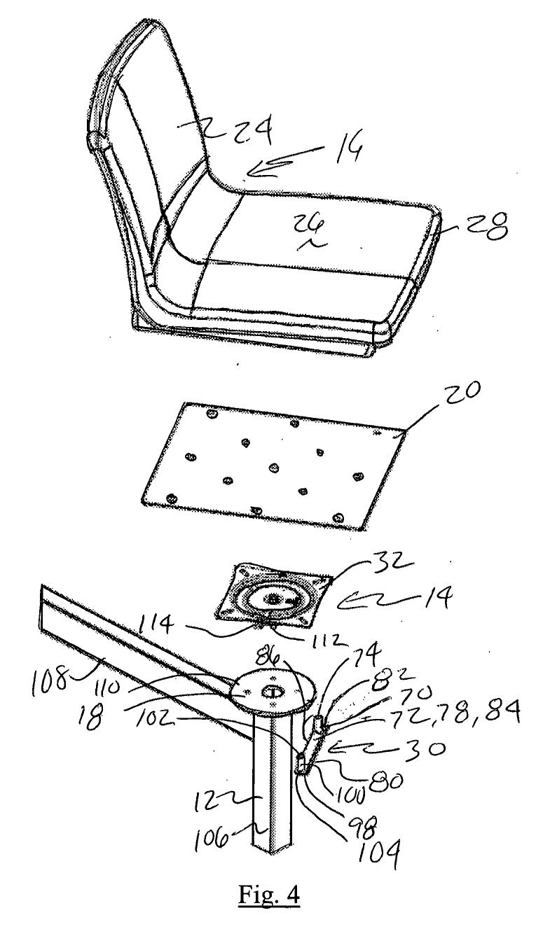

Referring to FIG. 2, the chair 16 may pivot about base plate 18 by swivel mechanism 14 between base plate 18 and chair 16. Base plate 18 has a generally round shape. A U-shaped tilt stop 30 may be mounted to the swivel mechanism 14 to engage either the base plate 18 or a portion of swivel mechanism 14 when a tilting force 94 may be applied to the swivel mechanism 14 in a generally perpendicular direction to the axis of rotation 31. A pinch guard 19 may be mounted on the swivel mechanism 14 to guard pinch point between swivel stop 112, 114 (FIG. 4).

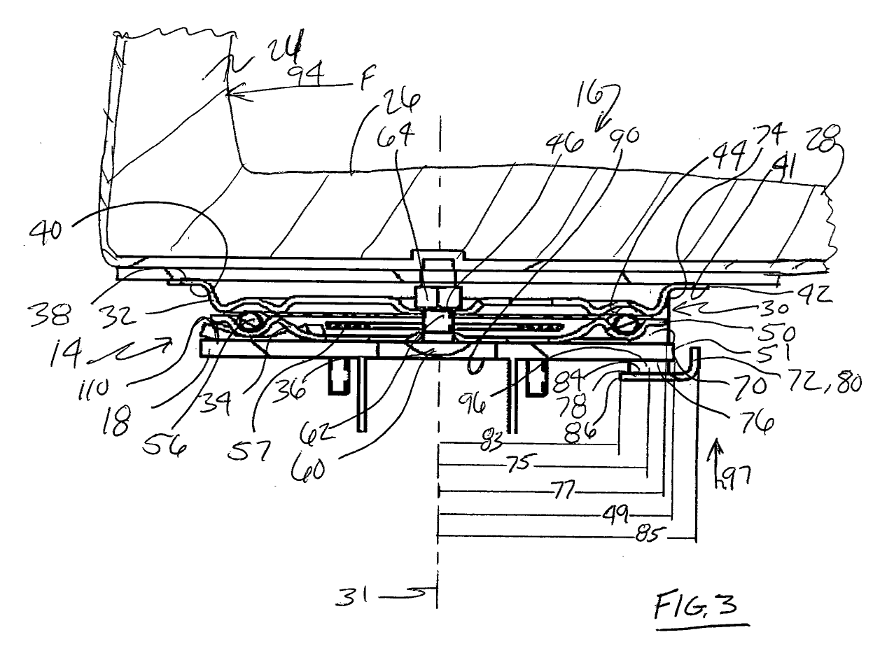

Referring to FIG. 3, the swivel mechanism 14 further comprises a top swivel plate 32, a bottom swivel plate 34 and a pivot pin 36. Top mounting plate 32 comprises a top surface 38 attached to the chair plate 20 by attachment means such as threaded fasteners or the like. Top mounting plate 32 further comprises a bottom surface 40, and outer edge 42, a bearing track 44 and a pivot pin aperture 46. Base plate 18 may further comprise a generally round shape having a first radius of 49 and a base front 51. Bottom mounting plate 34 further comprises a generally round shape having a second radius 77, a bottom 48 attached to base plate 18, a front edge 50, a bottom bearing track 52 and a pivot pin opening 54. Second radius 77 may be smaller than first radius 49. A bearing 56 may be disposed in bearing track 52 between the top swivel plate 32 and bottom swivel plate 34 to rotationally support the top swivel plate 32 and bottom swivel plate 34 in spaced relation to each other. A spring 57 may also be connected between top swivel plate 32 and bottom swivel plate 34 to return the chair 16 to a predetermined position having seat front 28 aligned with front edge 50 of the bottom swivel plate 34 and a front portion 41 of the outer edge 42 of the top swivel plate 32. Base front 51 may be generally aligned with seat front 28, bottom swivel plate front edge 50 and top swivel plate front portion 41 and adjacent to tilt stop 30 when bottom swivel plate 34 may be concentrically mounted on base plate 18.

Continuing to refer to FIG. 3, the pivot pin 36 comprises a head 60, a shaft 62 and a fastener 64. The shaft 62 has a first end on the head 60. The shaft 62 extends through the top pin opening 46 and bottom pivot pin opening 54. Head 62 bears against bottom plate 34 and fastener 64 may be attached to shaft 62 against top swivel plate to hold the mounting plates 32, 34 between the fastener 64 and head 62. Head 62 bears against bottom swivel plate 34 to hold top swivel plate 32 and bottom swivel plate 34 together. Pivot pin shaft 62 may rotate in pivot pin opening 54 or pivot pin aperture 46 to allow pivotal rotation about axis of rotation 31.

Continuing to refer to FIG. 3, the tilt resistant bracket 30 comprises an inverted U-shaped bracket having a first leg 70 and a base plate catch 72. The first leg 70 comprises a first top end 74 and a first bottom end 76. First bottom end 76 extending in a generally downward direction and generally parallel to the axis of rotation 31 to a position below base plate 18. Base plate catch 72 may be formed from angle iron having a lip 78, a shield 80 and a first end 82. Shield 80 may be a part of the base plate catch or may be a separate part of the anti tilts mechanism 10. Shield 80 may be extended around anti tilt mechanism 10 to cover swivel stops 112, 114. The first embodiment in FIG. 3, illustrates first end 82 may be attached to the first bottom end 76 of the first leg 70. Lip 78 further comprises an engaging surface 84 and an inner edge 86. Inner edge 86 of lip 78 may be disposed tangent to a fifth radius 83 from the axis of rotation. Fifth radius 83 being generally smaller than first radius 49. Engaging surface 84 may be generally parallel to the bottom 90 of base plate 18 and perpendicular to the axis of rotation 31. Shield 80 may be disposed in a generally parallel orientation to the axis of rotation 31. A tilting force 94 may be applied to chair 16 by user (not shown) leaning against the chair back 24. This tilting force 94 may be translated to a bending force against pivot pin 60 which may urge a separation between the bottom swivel plate 34 and front portion 41 of top swivel plate 32. This bending force 94 may cause the tilt stop 30 to travel in a generally upward direction 97 causing top swivel plate 32 to move upward thereby engaging base plate 18 front portion 51 with base plate catch 72 at pinch point 96 to resist chair tilting. Shield 80 may be disposed adjacent pinch point 96 generally located between top swivel plate 32 and base plate 18 near base plate front edge 51.

Referring to FIG. 4, the chair 16 may be mounted on chair plate 20 which may be adapted to attach to top mounting bracket 32. Tilt stop 30 further comprises a second end 98 on base plate catch 72 and a second leg 100. Second leg 100 may be similar to first leg 70 having a top end 102 adapted to attach to the top swivel plate 32 and a bottom end 104 attached to the second end 98 of the tilt stop 30. The base 12 may comprise a floor support 106 and a leveling support 108 on base plate 18. Base plate 18 has a top surface 110 adapted to engage and attach to swivel mechanism 14. A swivel limiting means may comprise a pair of swivel stops 112, 114 may be attached to swivel mechanism 14 to limit the angular rotation of the top swivel plate 32 with respect to bottom swivel plate 34.

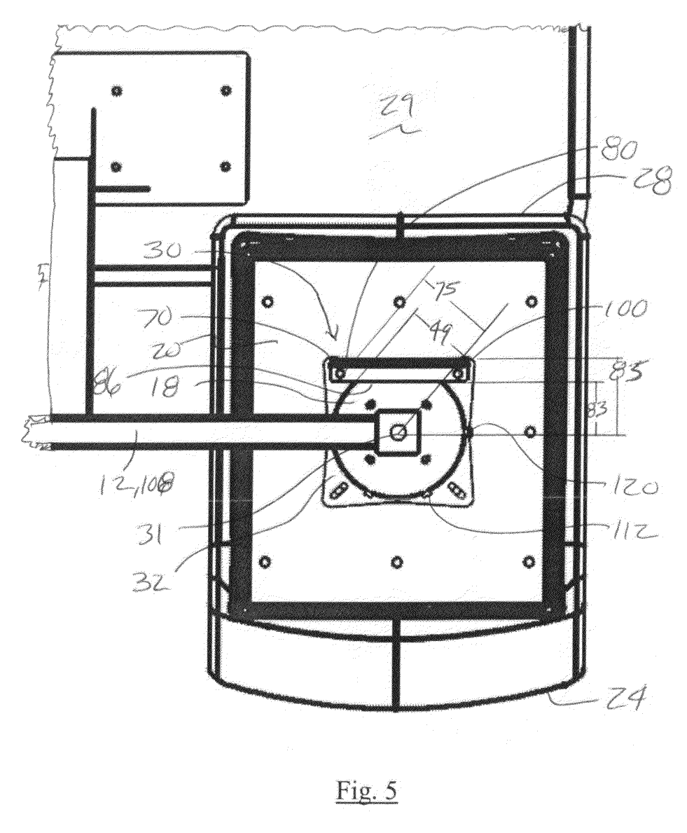

Referring to FIG. 5, swivel mechanism 14 generally comprises the top swivel plate 32, on chair 16 and the base 12 to hold the chair front 28 adjacent to a table 29. First leg 70 may be attached to top mounting bracket 32 at a predetermined third radius 75. Third radius may be generally larger than second radius 77, having leg mounted outside bottom swivel plate 34. Shield 80 may be disposed generally perpendicular to a fourth radius 85 from pivot pin 60. Fourth radius 85 being generally greater than the first radius 49. Tilt stop 30 may be attached to top mounting bracket 32 having base plate catch 72 adjacent to base plate 18 and adapted to engage base plate 18. Lip 82 may be disposed below base plate 18 having a lip edge 86 disposed generally perpendicular to a fifth radius 83. Fifth radius may be generally smaller than second radius. Swivel limiting cogs 120 on bottom swivel plate 34 are adapted to engage swivel stops 112, 114 (FIG. 4) on top swivel plate 32 to limit the angle of rotation of chair 16 about the axis of rotation 31.

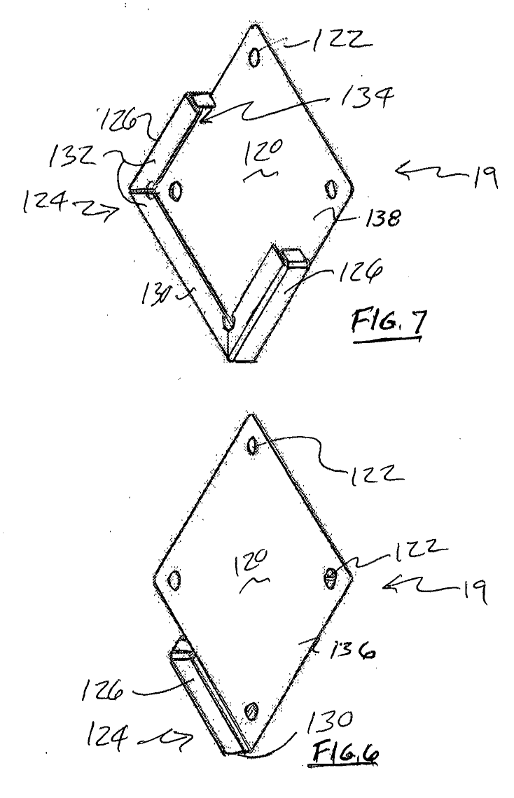

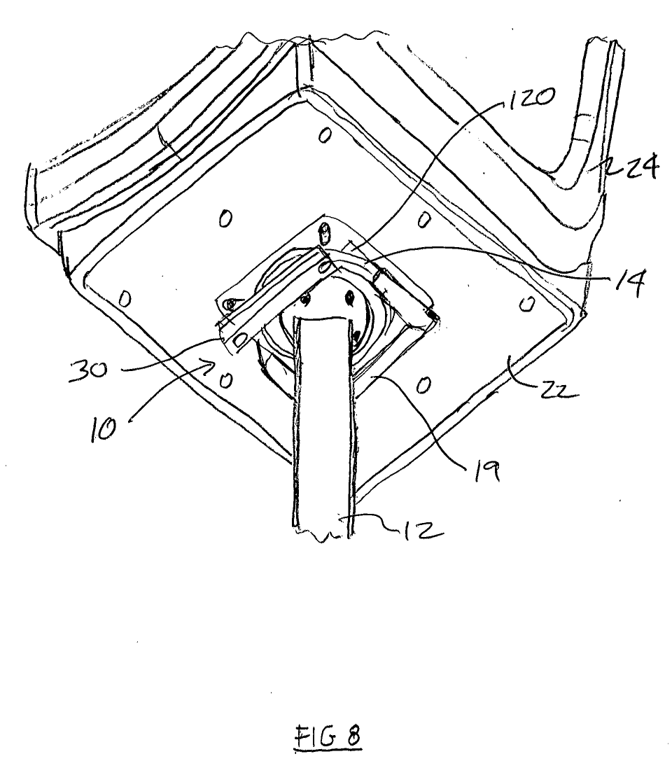

Referring to FIGS. 6 and 7, pinch guard 19 comprises a guard mounting plate 120 may have a plurality of holes 122 adapted to align with mounting holes 40, 41. Pinch guard 19 further may comprise guard 124 having side plate 126 and end plate 130. Each of side plate 126 and end plate 130 may be formed on mounting plate 120 such as formed by bending a single piece of metal at appropriate positions and angles as is known in metal forming. Pinch guard 19 may also be formed of plastic or other resilient material. Side plate 126 and end plate 130 may also have enclosing cover 132 creating a guarded space 134 between mounting plate 120 and cover 132. Guard mounting plate may have a top surface 136 on chair bottom 22 (FIG. 2) and bottom surface 138 on swivel assembly 14.

Referring to FIG. 8, anti-tilt swivel mechanism 10 may be mounted between chair 16 and base 12. Pivot guard 19 may be mounted generally toward the rear of the chair 16 to cover tilt stop 112, 114. Tilt stop 30 may be mounted generally toward the front of chair 16 to engage base plate 18 in the event of a tilting force 94 (FIG. 2) applied to the chair back 24.

It should be understood, a user (not shown), sitting in the chair 16 may lean back in the chair 16 and exert a tilting force 94 (FIG. 2) on the chair back mechanism 14 assembly. Tilting force 94 is translated to a bending force on pivot pin 36. Bending force on pivot pin 36 may cause top swivel plate 32 and bottom swivel plate 34 to be urged away from their generally parallel relationship with top swivel plate 32 on chair 16 and bottom swivel plate 34 on base 12. This urging of a change of relative position between top swivel plate 32 and bottom swivel plate 34 is urging the front portion of top swivel plate 32 to separate from a front portion of bottom swivel plate 34 which may bend either top swivel plate 32 or bottom swivel plate 34. The bending force is limited and damage prevented by locking top swivel plate 32 to base plate 18 with tilt stop 30 on top swivel plate 32 engaging bottom swivel plate 34 or base plate 18. Tilt stop 30 engaging base plate 18 limits the bending force applied to pivot pin 36 preventing bearing 56 from falling out of anti tilt mechanism 10 and damage by bending to top swivel plate 32 and bottom swivel plate 34.

Although the description above contains many specifications, these should not be construed as limiting the scope of the invention but as merely providing illustrations of some of the embodiments of this invention. Thus, the scope of the invention should be determined by the appended claims and their legal equivalents rather than by the examples given. Further, the present invention has been shown and described with reference to the foregoing exemplary embodiments. It is to be understood, however, that other forms, details, and embodiments may be made without departing from the spirit and scope of the invention which is defined in the following claims.

We claim:

1. An anti-tilt swivel seat mechanism mounted between a chair and a chair base, the chair having a chair seat and a chair bottom, the anti-tilt swivel seat mechanism comprising:
a base plate on the chair base, the base plate having a front edge;
a top swivel plate on the chair bottom, a bottom swivel plate on the chair base, a means for pivotally attaching the top swivel plate to the bottom swivel plate; and
a tilt stop on the top swivel plate, the tilt stop comprising a first leg having a first top end and a first bottom end, the first top end on the top swivel plate, the first bottom end extending away from the chair bottom, a base plate catch on the first bottom end, the bottom swivel plate in spaced relation to the top swivel plate, the base plate front edge intermediate the base plate catch and the top swivel plate.

2. The invention of claim 1, wherein the base plate catch further comprises a lip and a shield, the lip adapted to engage the front edge of the base plate, the shield adjacent the front edge.

3. The invention of claim 2, further comprising a second leg having a second top end and a second bottom end, the second top end on the top swivel plate, the second bottom end on the base plate catch, the base plate front edge between the first bottom end and the second bottom end.

4. The invention of claim 1, wherein the base plate is generally round having a first radius, the front edge having an arcuate shape, the means for connecting the top swivel plate to the base plate further comprising a bottom swivel plate having a front edge, the bottom swivel plate secured to the base plate, the bottom swivel plate attached to the top swivel plate.

5. The invention of claim 4, wherein the bottom swivel plate is generally round, the bottom swivel plate having a second radius, the second radius smaller than the first radius, the bottom swivel plate mounted in a generally concentric relationship with the base plate, whereby the base plate front edge extends from the front edge of the bottom mounting plate.

6. The invention of claim 2, wherein the bottom swivel plate further comprises a generally round shape having a second radius, the second radius smaller than the first radius, the bottom swivel plate mounted in a generally concentric relationship with the base plate.

7. The invention of claim 6 wherein the pivotal connection between the top swivel plate and the bottom swivel plate further comprises a pivot pin attached to one of the top swivel plate or bottom swivel plate and pivotally connected to the other of the top swivel plate or bottom mounting plate.

8. The invention of claim 1, wherein the pivotal connection between the top swivel plate and the bottom swivel plate further comprises a bearing disposed between the top swivel plate and bottom mounting plate.

9. The invention of claim 3, further comprising a pivotal connection between the top swivel plate and the bottom mounting plate, the pivotal connection comprising a pivot pin rotatable connected between the top and bottom mounting plates proximate the center of the first radius, a bearing disposed between the top swivel plate and the bottom mounting plate, the bearing concentrically disposed at a third radius, the third radius smaller than the second radius, whereby the tilt stop engages the base plate between the first radius and the third radius.

10. The invention of claim 9, wherein the tilt stop further comprises a lip and a shield disposed adjacent to the base plate front edge at a fourth radius, the fourth radius being generally greater than the first radius, the lip extending from the shield generally toward the pivot pin to a predetermined point between the pivot pin and the first diameter, the lip adapted to engage the base plate when a bending force is applied to the pivot pin, whereby the shield covers a pinch point between the tilt stop and the base plate.

11. The invention of claim 3, wherein the base plate catch is disposed generally parallel to the base plate.

12. The invention of claim 9, further comprising a means for limiting angular pivoting of the chair with respect to the chair base.

13. A method of adapting a swivel seat mechanism connecting a chair to a chair base comprising the steps, not necessarily in the order listed comprising;
providing a base plate on the chair base, a top swivel plate on the chair, a bottom swivel plate on the base plate, the base plate having a generally round shape having a first radius;
providing a swivel mechanism on the top swivel plate, the swivel mechanism comprising a pivot pin connected between the top swivel plate and the bottom swivel plate, the bottom swivel plate having a second radius, the second radius smaller than the first radius;
providing a tilt stop on the top swivel plate, the tilt stop having a first leg and a base plate catch, the first leg having a top end and a bottom end, the base plate catch having a first end and a lip;
attaching the top end of the first leg to the top swivel plate such that the second end of the first leg is adjacent the base plate;
attaching the first end of the base plate catch to the bottom end of the first leg;
orienting the swivel mechanism such that the first leg is adjacent the front edge of the base plate; and
attaching the bottom swivel plate generally concentrically to the base plate having the base plate front edge adjacent to the lip, the front edge of the base plate between the lip and the top swivel plate.

14. The method of claim 13, further comprising the step of attaching a second leg to the top swivel plate generally parallel to the first leg, the second leg having a second top end on the top swivel plate and a second bottom end adjacent the bottom mounting plate, attaching the second bottom end to a second end of the base plate catch forming a U-shaped tilt stop, whereby the bottom swivel plate front edge extends between the first leg and second leg.

15. The method of claim 14, further comprising the step of forming a shield on the base plate catch, the shield on the lip, the lip adjacent to the front edge of the base plate, whereby the front edge of the base plate is between the shield and the pivot pin.

16. The method of claim 14, further comprising the step of mounting the first leg and the second leg at a leg radius from the pivot pin, the leg radius larger then the second radius.

17. The method of claim 14, further comprising the step of disposing the first leg and second leg generally parallel to an axis of rotation of the pivot pin, and adapting the base plate catch stop having the base plate front edge intermediate the base plate catch and the top swivel plate.

18. The method of claim 15, further comprising shielding a pinch point at an upper surface of the lip by disposing the pinch point between the shield and the pivot pin.

19. The method of claim 13, further comprising forming the base plate catch from angle iron having a shield on the lip.

20. An anti-tilt swivel mechanism mounted between a chair and a generally round base plate, the chair having a back, seat and a bottom, the anti tilt mechanism comprising:
a pivotal connection between the base plate and the chair comprising an axis of rotation, a top swivel plate, a bottom mounting plate, a pivot pin and a bearing, the top swivel plate having a top attached to the chair bottom, the pivot pin pivotally attached to the top swivel plate and the bottom mounting plate at the axis of rotation and, the bearing disposed between the top swivel plate and the bottom mounting plate, the generally round base plate having front edge and a first radius, the bottom swivel plate having a generally round shape with a second radius, the second radius smaller than the first radius, the bottom swivel plate concentrically positioned on the chair base plate, the bottom swivel plate having a bottom attached to the chair base;
a tilt stop on the top swivel plate, the tilt stopped comprising a first leg, second leg, and a base plate catch, the first leg comprising a first top end on the top swivel plate and a first bottom end adjacent the chair base plate, the second leg comprising a second top end on the top swivel plate and a second bottom end adjacent the chair base plate, the second leg spaced from the first leg, the first leg and the second leg each spaced from the pivot pin by a predetermined distance larger then the second radius, the base plate catch comprising an angle iron portion having a first catch end, second catch end, a lip and a shield, the first catch end attached to the first bottom end, the second catch end attached to the second bottom end, the lip and shield between the first catch end and the second catch end, the lip generally perpendicular to an axis of rotation about the pivot pin, the shield of generally parallel to the axis of rotation, the shield extending upward from the lip adjacent to the front edge of the base plate, the lip disposed adjacent to and below the front edge of the base plate, the lip having an inner edge disposed at the lip radius with respect to the axis of rotation, the lip radius smaller than the first radius whereby a tilting force applied to the chair urges the catch to move generally upward thereby engaging the base plate front edge.
